(19) United States
(12) Patent Application Publication
(10) Pub. No.: US 2025/0102210 A1
(43) Pub. Date: Mar. 27, 2025

(54) CENTRIFUGE, METHOD FOR OPERATING A CENTRIFUGE AND COMPUTER-READABLE MEDIUM

(71) Applicants: Sigma Laborzentrifugen GmbH, Osterode (DE); Sartorius Stedim Biotech GmbH, Göttingen (DE)

(72) Inventor: Eckhard Tödteberg, Osterode (DE)

(73) Assignees: Sigma Laborzentrifugen GmbH, Osterode (DE); Sartorius Stedim Biotech GmbH, Göttingen (DE)

(21) Appl. No.: 18/977,545

(22) Filed: Dec. 11, 2024

Related U.S. Application Data
(63) Continuation of application No. PCT/EP2023/066700, filed on Jun. 20, 2023.

(30) Foreign Application Priority Data
Jun. 30, 2022 (EP) 22 182 396.6

(51) Int. Cl. F25B 49/02; B04B 7/02; B04B 13/00; B04B 15/02

(52) U.S. Cl. CPC F25B 49/022; B04B 7/02; B04B 13/00; B04B 15/02; F25B 2600/2501; F25B 2700/21

(57) ABSTRACT

The invention relates to a centrifuge, in particular a continuous flow centrifuge, a biotechnical centrifuge or a blood centrifuge. The centrifuge comprises a refrigerant circuit. According to the invention, the outlet side of a controllable compressor is connected to an inlet side of an evaporator via a bypass line with a valve arranged therein. In a normal operation mode, a centrifuge vessel is cooled exclusively via the control of the compressor and an expansion unit while the valve is closed. If, on the other hand, a tolerance range of the target temperature in the centrifuge vessel is left, the valve is opened in order to bring about heating and thus a return of the temperature in the centrifuge vessel to the tolerance range.

### CROSS REFERENCE TO RELATED APPLICATIONS

This application is a continuation of International Application No. PCT/EP2023/066700 with an international filing date of Jun. 20, 2023 and claiming priority to co-pending European Patent Application No. EP 22 182 396.6 entitled “Zentrifuge, Verfahren zum Betrieb einer Zentrifuge und computerlesbares Medium”, filed on Jun. 30, 2022, the disclosures of which are hereby incorporated herein by reference in their entirety.

### FIELD OF THE INVENTION

The invention relates to a centrifuge.

The centrifuge is preferably a continuous flow centrifuge in which at least one medium is at least temporarily supplied to and/or discharged from a centrifugation chamber while the centrifugation chamber rotates. The at least one medium is, in particular, the medium to be centrifuged, a rinsing liquid, a buffering solution or a modified medium extracted from the centrifuged medium or a sediment in the centrifugation chamber. To give only a few non-limiting examples of the invention, the continuous flow centrifuge may be a blood centrifuge, in which the medium to be centrifuged is blood and the extracted modified medium or the sediment are blood cells or—particles, or a centrifuge by means of which cells, microcarriers or other particles contained in the medium shall be obtained from a medium. It is also possible that the centrifuged medium is not a pure liquid, but rather a solution or suspension with particles such as cells, cell debris or—particles, etc. A continuous flow centrifuge of this type is used, for example, for the production of biopharmaceutical or biotechnological products in biopharmaceutical companies or in bio-processing applications. The continuous flow centrifuge can be used, for example, to obtain and/or clarify the cells or microcarriers, whereby the cells obtained in this way can be used for cell therapy. Further areas of application are (without limitation to this) the production of vaccines or the processing of blood for the purpose of obtaining blood cells. Such continuous flow centrifuges are marketed, for example, by the company Sartorius AG, Otto-Brenner-Straße 20, 37079 Göttingen, Germany, and affiliated companies under the label “Ksep” (registered trademark), see also
www.sartorius.com/en/products/process-filtration/cell-harvesting/ksep-systems
(Date of inspection: 28.06.2022).

A rotor of such a continuous flow centrifuge comprises in particular four centrifugation chambers, which can be embodied as bags held on the rotor body and which are evenly distributed around the circumference. The centrifugation chambers are arranged at a radial distance from the axis of rotation of the rotor. A first connection line opens at a radially inner location into a centrifugation chamber, while a second connection line opens at a radially outer location into the centrifugation chamber. In a first operating phase, a first medium embodied as blood, for example, is fed to the centrifugation chamber via the second connection line while the centrifugation chamber rotates with the rotor. In the centrifugation chamber, particles contained in the medium are deposited radially on the outside as a result of the centrifugation, while the residual medium (i.e. the medium supplied radially on the outside reduced by the particles pushed radially outwards) is discharged from the centrifugation chamber radially on the inside via the first connection line. In this first operating phase, the first connection line is therefore a discharge line, while the second connection line is a supply line. As this operation continues, the proportion of particles and their concentration in the centrifugation chamber increases until the chamber is largely or completely filled with particles. In a subsequent optional second operating phase, the particles in the centrifugation chamber are washed. For this purpose, a washing or buffering solution is fed into the centrifugation chamber via the second connection line. The washing or buffering solution rinses through the centrifugation chamber and is discharged radially inwards via the first connection line. In this operating phase, the centrifugation chamber also rotates together with the rotor so that the particles are prevented from exiting the centrifugation chamber together with the washing or buffering solution via the first connection line as a result of the centrifugation force. Also during the second operating phase, the first connection line serves as a discharge line for the washing or buffering solution, while the first connection line serves as a feed line for the washing or buffering solution. In a subsequent third operating phase, the centrifugation chamber continues to rotate together with the rotor. In the third operating phase, the direction of flow through the centrifugation chamber is reversed and the particles are removed from the centrifugation chamber via the second connection line, while the washing or buffering solution is fed into the centrifugation chamber via the first connection line. The third operating phase ends when all the particles have been removed from the centrifugation chamber. This is followed by successive cycles with the three operating phases described before.

Such continuous flow centrifuges, for which the invention can be used, are known, for example, from EP 3 936 601 A1 (corresponding to US 2023/0250384 A1), EP 2 310 486 B1 (corresponding to U.S. Pat. No. 9,090,910 B2, U.S. Pat. No. 9,279,133 B2 and U.S. Pat. No. 10,208,283 B2), EP 2 485 846 B1 (corresponding to U.S. Pat. No. 9,839,920 B2 and U.S. Pat. No. 10,888,878 B2), U.S. Pat. Nos. 4,216,770, 4,419,089, 4,389,206 and 5,665,048.

It is possible that the centrifuge concerned by the invention has a horizontal rotation axis, whereby an exchange of the media (e.g. blood, a washing fluid and particles) can take place during centrifugation in the area of the rotating rotor shaft. The continuous flow centrifuge embodied as such can be a blood centrifuge, for example, in which blood is centrifuged as the medium.

Furthermore, the invention relates to a method for operating such a centrifuge and a computer-readable medium.

### BACKGROUND OF THE INVENTION

EP 2 814 617 B1 (corresponding to U.S. Pat. No. 10,449,556 B2) provides the following information on the state of the art for cooling a laboratory centrifuge:

During centrifugation, especially in very fast-rotating laboratory centrifuges, heat is generated in the centrifuge vessel during the rotation of the centrifuge rotor due to air friction and the introduction of electrical power loss. As the centrifuge vessel is closed by a lid to prevent the centrifuged product from escaping, this heat input cannot be easily discharged and leads to an increase in the temperature of the centrifuged product. However, this increase in temperature is undesirable as it can lead to the destruction or unusability of the centrifuged product. Usually, the products must be kept at a defined temperature, for example at temperatures of 4° C., 22° C. or 37° C. (depending on the application). For this reason, precautions have already been taken in the past to avoid an increase of the temperature of the centrifuged product, whereby indirect cooling is often used. When using this indirect cooling, the rotor is usually enclosed in the centrifuge vessel under the centrifuge lid and no cooling channel or similar is provided. The air therefore only circulates within the centrifuge vessel. Cooling is now achieved by a second medium that is routed past the outside of the vessel or within the vessel wall. For this purpose, a refrigerant circuit with a compressor, tubes and a heat exchanger is often provided, by means of which a special refrigerant is guided past the vessel via tube lines, which for example lie spirally against the centrifuge vessel, i.e. the side walls and the bottom of the vessel, in order to transport heat away. In contrast to “coolants”, such as those used for the cooling water circuit of cars, a refrigerant undergoes phase changes as it passes through the refrigerant circuit, usually from a liquid phase to a gas phase. With such a refrigerant, it is also possible to control the temperature of a coolant comprising a temperature below the ambient temperature. A refrigerant circuit can also be used to cool the product to a temperature below the ambient air temperature. Laboratory centrifuges of this type are known, for example, from DE 38 18 584 A1 or JP 2011-255330 A. Such refrigerant circuits 1 comprise an evaporator 2, which is usually arranged in a ring around the centrifuge vessel 3, a compressor 4, a condenser 5 and an expansion unit 6 (see FIG. 1). The expansion unit 6 is dimensioned for the maximum possible load case (i.e. the maximum speed of the centrifuge rotor (not shown)). It is already known that the expansion unit 6 (pressure equalization element between the high-pressure and low-pressure sections of the refrigerant circuit 1 being effective when the compressor 4 is at a standstill) is embodied as a capillary tube or thermo-static injection valve 7 (abbreviated to “TEV”). In conjunction with a pressure-controlled temperature sensing system 8 downstream of the evaporator 3, this thermo-static injection valve 7 is used to automatically increase or reduce the refrigerant flow in the refrigerant circuit 1 at the evaporator inlet VE depending on the temperature sensed. This requires overheating of the refrigerant at the evaporator outlet VA, so that an overpressure is created which is fed directly to a spring 9 of the thermo-static injection valve 7 in order to actuate it. More precisely, there is a certain temperature at evaporator outlet VA. The sensor 10 of the thermo-static injection valve 7 is attached to the evaporator outlet VA, which also contains a refrigerant that can correspond to the refrigerant of the refrigerant circuit 1. Due to the temperature at the evaporator outlet VA, the refrigerant comprises a corresponding pressure, which then acts on the thermo-static injection valve 7 and the counterforce of the spring 9, thus opening or closing the thermo-static injection valve 7. Other load cases can be partially, but usually only imprecisely, controlled via another control element, which in this case is a frequency—or speed-controlled compressor 4. The fact that the refrigerant must be superheated in order for the thermo static injection valve 7 to function means that the evaporator capacity cannot be fully utilized, with only approx. 95% of the evaporator area being used. Due to the required overheating, there is a temperature difference of approx. 7 K between the evaporator inlet VE and the evaporator outlet VA. Another significant disadvantage of such known refrigerant circuits 1 in centrifuges is that the compressors 4 can only be controlled relatively imprecisely and within certain limits in terms of their power, so that in various partial load cases and low load cases the compressor 4 may have to be switched off completely. However, this is not always possible because compressors 4 usually have a minimum running time to ensure the flow in the internal oil circuit. Conversely, due to the increased heating of the drive motor of the compressor 4 during start-up and the necessary pressure equalization or pressure difference reduction between the high and low pressure sections, there is also a certain minimum stop time for such compressors 4, which is why the control options via the compressor 4 are severely limited, especially in the lower power range. Another disadvantage is that vibrations occur when the compressor 4 of a refrigerant circuit 1 starts or stops. These vibrations influence the operating behavior of the centrifuge, increase the remixing rate in the rotor after the centrifuge has come to a standstill and impact adjacent laboratory equipment and the like. Finally, frequent switching off and on of the compressor 4 shortens its service life.

Against this background, EP 2 814 617 B1 proposes a refrigerant circuit 1 (see FIG. 2) in which the expansion unit 6 is embodied as an electronically continuously or discretely controllable throttle (which can also be embodied as an electronic injection valve 11). Temperature sensors 12, 13, 14 sense the temperatures of the refrigerant at the inlet VE of the centrifuge vessel 3, the actual temperature in the centrifuge vessel 3 and the temperature at the outlet VA of the centrifuge vessel 3. The temperature signals of the temperature sensors 12, 13, 14, a target temperature of the centrifuge vessel 3 and a tolerance range of the actual temperature of the centrifuge vessel 3 with respect to the target temperature (in particular ±5 K) are fed to an electronic control unit. The electronic control unit controls the electronic injection valve 11 and the controllable compressor 4 for a temperature control. A bypass line 15 connects the connection line 16 between the electronic injection valve 11 and the evaporator 2 with the connection line 17 between the outlet of the compressor 4 and the evaporator 2. An electronic injection valve 18 is arranged in the bypass line 15. It is possible that the electronic control unit also controls the electronic injection valve 18. According to EP 2 814 617 B1, switching between coarse control and fine control takes place according to the needs as follows: The coarse control is used when the laboratory centrifuge is started until the actual temperature is within the tolerance range for a specified period of time. Then the switchover takes place and the fine control is generally maintained during further operation. Coarse control is only resumed if the actual temperature leaves the tolerance range despite of the fine control. During coarse control, only the compressor 4 is controlled, without the electronically controlled injection valves 11, 18 being controlled. In contrast, the power of the compressor 4 is not adjusted during fine control. Control then takes place via the control of the electronic injection valve 11. During fine control, the electronic injection valve 11 is controlled on the basis of three different criteria. Firstly, the electronic injection valve 11 is controlled for a reduction [or for an increase] if the actual temperature of the centrifuge vessel 3 tends to fall [or rise] within a predefined trend period, thereby reducing [or increasing] the flow of refrigerant. An opening of the electronic injection valve 11 is also triggered when the temperature of the refrigerant at the inlet VE of the evaporator 2 is lower than a predetermined threshold value of the temperature at the inlet VE of the evaporator 2, whereby this opening is maintained until the temperature is again higher than the predetermined threshold value of the temperature. In this way it is prevented that the compressor 4 is operated in the vacuum range. Finally, the difference between the temperatures at the outlet of the compressor VA and at the inlet of the compressor VE is also monitored. This difference should be between 0 K and 1 K in order to keep the utilization of the evaporator 2 at a maximum and to prevent liquid refrigerant from entering the compressor 4. If the difference falls below, the electronic injection valve 11 is closed further and/or the compressor frequency is reduced.

JP 2010-008022 A discloses a refrigerant circuit for a centrifuge in which refrigerant flows from a compressor via a condenser, a dryer and two capillary tubes arranged in series to an evaporator in a normal operation mode without any control options. If the cooling of the centrifuge vessel brought about in this way results in a temperature that is too low, a bypass valve is moved to an open position so that refrigerant can also flow via the bypass line from the outlet of the compressor via the capillary tube arranged downstream to the evaporator, whereby the refrigerant flowing via the bypass line bypasses the condenser and the capillary tube arranged upstream. To specify the refrigerant flows in the parallel line branches when the solenoid valve is open, the diameter of the upstream capillary tube is selected to be smaller than the diameter of the downstream capillary tube.

EP 0 295 377 A2 discloses a refrigerant circuit of a centrifuge, in which the outlet of a compressor is connected to a cooling coil of the centrifuge vessel via a parallel connection of a hot line branch and a cold line branch, in which a condenser is arranged. Pulse-width modulated valves are arranged in the hot line branch and in the cold line branch, these valves being operated in an alternating or push-pull mode. The heat supplied to the cooling coil depends on the pulse width, which is controlled on the basis of the measured temperature in the centrifuge vessel.

### SUMMARY OF THE INVENTION

The invention relates to a centrifuge which has a centrifuge vessel. Furthermore, the centrifuge comprises a refrigerant circuit in which a refrigerant circulates, which preferably undergoes a phase change in the refrigerant circuit. The refrigerant circuit is used to cool the centrifuge vessel with the aim of ensuring a target temperature within a tolerance range in the centrifuge vessel.

In the centrifuge, the temperature in the centrifuge vessel is sensed (directly or indirectly) by means of a temperature sensor. To give only a few examples which do not limit the invention, the temperature sensor can be arranged in a wall of the centrifuge vessel or a lid of the centrifuge, in particular as close as possible to the centrifuge chamber of the centrifuge vessel or with direct adjacency thereto. However, it is also possible that the temperature sensor is integrated into the rotor or a centrifuge container for the centrifuged product held on the rotor (see also the disclosure in EP 3 560 592 A2 (corresponding to EP 3 560 592 B1)).

The refrigerant circuit used in one embodiment comprises a compressor whose speed, frequency and/or power can be controlled. Furthermore, the refrigerant circuit has a liquefier, in particular a condenser. Furthermore, an adjustable expansion unit is arranged in the refrigerant circuit. The refrigerant circuit also comprises an evaporator that delivers cooling energy to the centrifuge vessel. For example, the evaporator can surround the centrifuge vessel with a line or the line can be integrated into a wall of the centrifuge vessel. The adjustable expansion unit is preferably arranged upstream of the evaporator in the refrigerant circuit. The adjustable expansion unit can be used to control the flow of the refrigerant and/or the expansion of the refrigerant and thus influence the design of the pressure and temperature conditions of the refrigerant in the low-pressure section and in the area of the evaporator. The adjustable expansion unit can be embodied as a passive device, in particular a thermo-static injection valve, or as an active device, in particular in the form of an electronically controlled throttling device or another electronically controlled expansion unit.

In one embodiment, a connection line between the compressor and the condenser is connected to the connection line between the expansion unit and the steamer via a bypass line. Preferably, the bypass line bridges the condenser and the adjustable expansion unit. Here, the bypass line can provide a connection between the high-pressure section and the low-pressure section of the refrigerant circuit. To control this connection, an electronically controlled valve is arranged in the bypass line to control the flow through the bypass line.

It is possible that an electronic control unit comprises control logic. The control logic monitors a difference between a predetermined target temperature in the centrifuge vessel and the temperature sensed by the temperature sensor, i.e. the actual temperature in the centrifuge vessel. If this difference is greater than a predetermined threshold value, the valve arranged in the bypass line is actuated by the control unit so that the flow rate through the bypass line is increased. This is preferably the case if a minimum capacity of the compressor has already been reached by the control by the control unit and/or the expansion unit has been controlled by the control unit in such a way that the maximum absorption of heat by the evaporator has been reached. Thus, the valve is preferably controlled to increase the flow rate through the bypass line when the conventional measures to prevent a reduction in the temperature in the centrifuge vessel have already been exhausted and the temperature still falls below the target temperature by the threshold value (which, without the measures proposed here, could possibly require the compressor to be switched off). In this case, the control of the valve causes more refrigerant to flow from the high-pressure side to the low-pressure side at a point upstream of the evaporator inlet. This increases the amount of warmer refrigerant on the high-pressure side that is mixed into the low-pressure side at the inlet of the evaporator, which ultimately means that less heat can be removed from the centrifuge vessel by the evaporator. In this way, an excessive reduction in the temperature in the centrifuge vessel can be counteracted, which is also possible without the compressor having to be switched off or the power of the compressor having to be reduced further or too much.

In principle, there is a wide range of options for the valve arranged in the bypass line in terms of design (e.g. seated valve, gate or sliding valve, . . . ), operating positions (continuous operating positions; any number of discrete operating positions) and control options, as long as the valve can be controlled by the electronic control unit. All suitable valves known from the prior art can be used. In one proposal, the valve is embodied as a 2/2-way solenoid valve comprising a larger opening position and a smaller opening position. It is possible, for example, that the smaller opening position is a shut-off position and the larger opening position is a let-through position. In this case, the valve is basically in the shut-off position, in which the bypass line is closed. Only if the difference between the target temperature in the centrifuge vessel and the temperature sensed by the temperature sensor is greater than the threshold value the 2/2-way solenoid valve controlled by the control unit to the let-through position. In this case, the 2/2-way solenoid valve can assume its shut-off position without electrical excitation by the control unit, while switching to the open position is possible by an electrical excitation. However, it is also possible to reverse the design of the valve so that it is transferred to the closed position with electrical excitation. In this case, the stable position of the valve, which can only be left by electrical excitation, can be secured by means of a spring. In another embodiment, the valve can be embodied as a bi-stable valve which, once the valve has been brought into the open position on the one hand and the closed position on the other hand, retains this position without requiring the valve to be energized. Electrical excitation of the valve is then only required to change the valve position in both directions.

There are various options for the criteria for controlling the 2/2-way solenoid valve to the let-through position. It is possible, for example, that the 2/2-way solenoid valve is controlled to the open position until the difference between the target temperature in the centrifuge vessel and the temperature sensed by the temperature sensor is again less than the threshold value or any other temperature that correlates with the target temperature. For a particularly simple embodiment, the control logic controls the 2/2-way solenoid valve for a predetermined period of time from the closed position to the open position. Here, the predetermined time period may depend on operating parameters of the centrifuge, which may relate to a rotational speed of the centrifuge, an ambient temperature of the centrifuge, the current product to be centrifuged and/or the type of rotor used in the centrifuge, to name just a few non-limiting examples. It is also possible that, during operation of the centrifuge and possibly also during a number of operating cycles, the time period for which the valve is controlled by the control logic into the open position is determined by a self-learning process.

Any expansion unit can be used, which can therefore also be an electronically controlled relaxation valve or an electronically controlled throttle. For a particularly simple embodiment, a passive thermo-static injection valve is used as an expansion unit.

A compressor of any design can be used in the centrifuge. Preferably a rolling piston compressor is used, the operation of which has proven to be very advantageous with regard to undesirable vibrations and can also be advantageous with regard to the operation of environmentally friendly refrigerants.

For one solution, instead of designing the valve as a 2/2-way solenoid valve, a valve comprising several different opening cross sections can be used. In this case, the valve can comprise several discrete operating positions that correlate with the different opening cross sections. It is also possible for the valve to have continuously different opening cross sections, whereby the different opening cross sections may or may not include a fully closed position and/or a fully open position. For example, the valve can be embodied as a proportional valve, which provides continuously different opening cross sections depending on the electrical excitation. It is also possible for the valve to provide several different opening cross sections by designing the valve as a pulse-width-modulated valve in which the duty cycle for the pulse-width modulation correlates with the opening cross section. For such embodiments, the control unit comprises control logic that induces a larger opening cross section in the event that the difference between the target temperature in the centrifuge vessel and the temperature sensed by the temperature sensor is greater than a threshold value. In this case, however, the increase in the opening cross section depends on the absolute value of the difference, a rate of change of the difference and/or the period of time that the difference is greater than the threshold value. It is possible, for example, that initially only a small increase in the opening of the valve is brought about. If the control logic of the control unit then determines that the temperature in the centrifuge vessel is still too low, the opening can be increased further. The opening cross section or its size can also be controlled on the basis of the operating parameters of the centrifuge, in particular the actual temperature in the centrifuge vessel.

In some embodiments the control logic of the control unit operates in two different modes:

A normal operation mode is present if the absolute value of the difference between the target temperature in the centrifuge vessel and the temperature sensed by the temperature sensor is less than the threshold value (or a second threshold value). In the normal operating mode, the control logic performs control (here covering open loop or closed loop control) exclusively by means of the adjustable expansion unit and/or by means of the adjustable compressor. In the normal operating mode, the valve is in a first position.

An exceptional operation mode is present if the absolute value of the difference between the target temperature in the centrifuge vessel and the temperature sensed by the temperature sensor is greater than the threshold value (or the aforementioned second threshold value). In the exceptional operation mode, the control logic moves the valve to a second position that differs from the first position. No additional control by means of the compressor takes place in the exceptional operating mode, and preferably no control by means of the adjustable expansion unit takes place either. For this proposal, in the first position of the valve, the opening cross section of the valve is smaller than the opening cross section of the valve in the second position.

If a 2/2-way solenoid valve is used as the valve, the first position can be the blocking or closed position, while the second position can then be the let-through or open position. If, on the other hand, other valve designs with an opening cross section that can be changed continuously or in discrete steps are used, any partial opening can be provided in the first position and/or second position.

In one embodiment the compressor in the centrifuge is operated permanently during operation of the laboratory centrifuge, whereby during operation the speed always corresponds to at least a minimum speed. The need to switch off the operation of the compressor can thus avoid, which is advantageous on the one hand with regard to the operation and service life as well as the lubrication conditions of the compressor and on the other hand is advantageous in order to avoid undesirable mixing of the centrifuged product as a result of the stopping and restarting of the compressor.

In a method for operating a centrifuge the centrifuge is basically designed as explained above in the various designs and further developments. In a method step, a test is first carried out to determine whether a difference between the target temperature in the centrifuge vessel and the temperature sensed by the temperature sensor is greater than a threshold value. If this test shows that the difference is greater than the threshold value, the flow rate through the bypass line is increased in the method.

For one proposal in the method the control of the flow of the refrigerant through the evaporator is (also or exclusively) provided by a passive thermo-static injection valve.

In the method it is possible that the refrigerant is conveyed in the refrigerant circuit by means of a rolling piston compressor.

Furthermore, it is possible in the method that the valve is controlled into several different opening cross sections (continuously or in discrete steps). If a difference between the target temperature in the centrifuge vessel and the temperature sensed by the temperature sensor is greater than a threshold value, the opening cross section is increased. The enlargement and the extent of the enlargement depend on the absolute value of the difference determined, the rate of change of the difference and/or the period of time that the difference is greater than the threshold value.

A test is carried out to determine whether the absolute value of the difference between the target temperature in the centrifuge vessel and the temperature sensed by the temperature sensor is less than the threshold value (or a second different threshold value).

If this is the case, the centrifuge is operated in a normal operation mode. In the normal operating mode, control is provided by means of the adjustable expansion device and/or by means of the compressor. In the normal operation mode the valve is in a first position.

If, on the other hand, the absolute value of the difference is greater than the threshold value (or the second threshold value), the centrifuge is operated in an exceptional operation mode. In the exception operating mode, the valve is controlled to a second position that differs from the first position. In the exceptional operation mode, there is no control by means of the compressor, and preferably there is also no control by means of the adjustable expansion unit. For the embodiment of the method, the opening cross section of the valve in the first position is smaller than the opening cross section of the valve in the second position.

In a further embodiment of the method, the compressor is operated permanently during operation of the centrifuge, whereby during this operation the number of revolutions always corresponds to at least a minimum number of revolutions.

Another aspect of the invention relates to a computer-readable medium comprising control logic for carrying out a method for operating a centrifuge as explained above. The control logic on such a computer readable medium can be used, for example, to retroactively enable the method to be carried out on an existing centrifuge or to upgrade the control software.

Advantageous developments of the invention result from the claims, the description and the drawings.

The advantages of features and of combinations of a plurality of features mentioned at the beginning of the description only serve as examples and may be used alternatively or cumulatively without the necessity of embodiments according to the invention having to obtain these advantages.

The following applies with respect to the disclosure—not the scope of protection—of the application as originally filed and the patent: Further features may be taken from the drawings, in particular from the shown geometries and the dimensions of a plurality of components relative to one another as well as from their relative arrangement and their operative connection. The combination of features of different embodiments of the invention or of features of different claims independent of the chosen references of the claims is also possible, and it is motivated herewith. This also relates to features which are illustrated in separate drawings, or which are mentioned when describing them. These features may also be combined with features of different claims. Furthermore, it is possible that further embodiments of the invention do not have the features mentioned in the claims which, however, does not apply to the independent claims of the granted patent.

The number of the features mentioned in the claims and in the description is to be understood to cover this exact number and a greater number than the mentioned number without having to explicitly use the adverb “at least”. For example, if a valve or an expansion unit is mentioned, this is to be understood such that there is exactly one valve or expansion unit or there are two valves or expansion units or more valves or expansion units. Additional features may be added to these features, or these features may be the only features of the respective product.

The reference signs contained in the claims are not limiting the extent of the matter protected by the claims. Their sole function is to make the claims easier to understand.

### BRIEF DESCRIPTION OF THE DRAWINGS

In the following, the invention is further explained and described with reference to preferred embodiments shown in the figures.

FIG. 1 schematically shows a laboratory centrifuge with a refrigerant circuit according to the state of the art.

FIG. 2 schematically shows a laboratory centrifuge with a refrigerant circuit according to EP 2 814 617 B1.

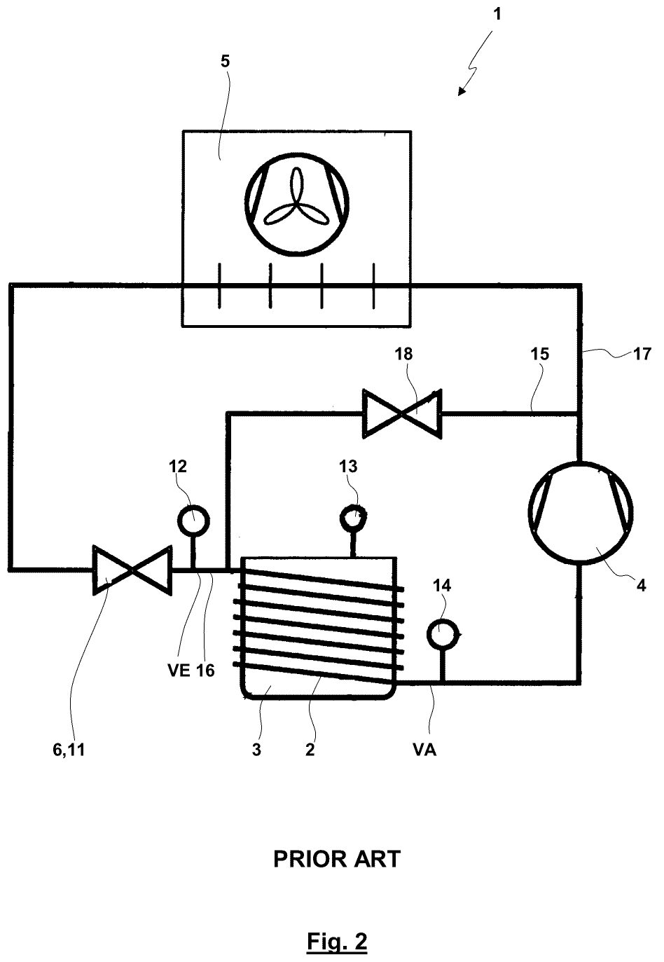

FIG. 3 schematically shows a centrifuge with a refrigerant circuit.

FIG. 4 schematically shows a method for operating a centrifuge with a refrigerant circuit.

### DETAILED DESCRIPTION

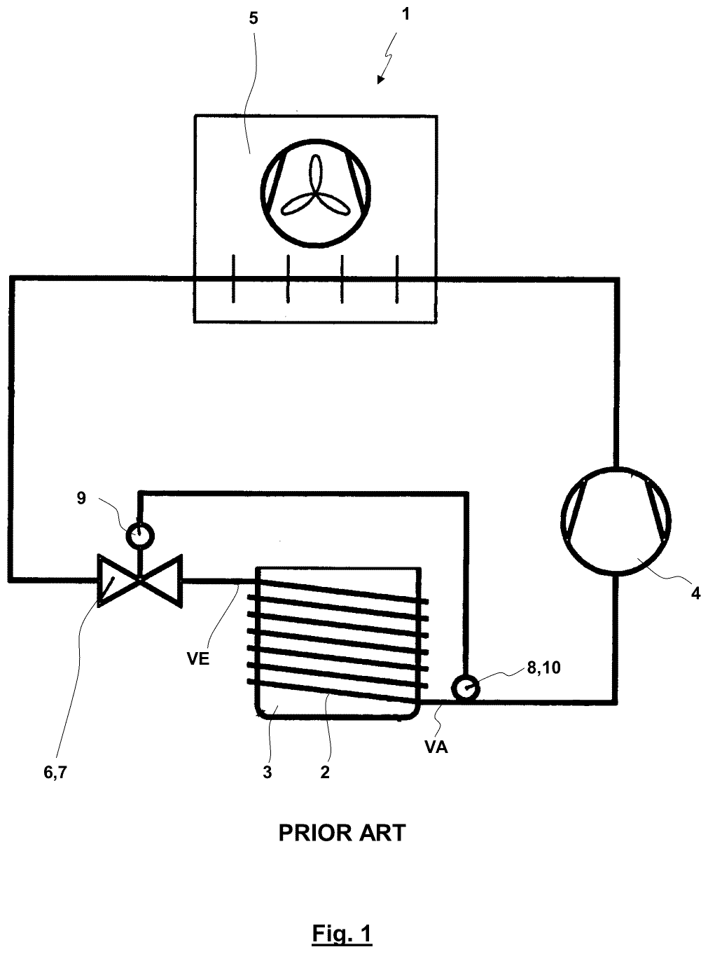

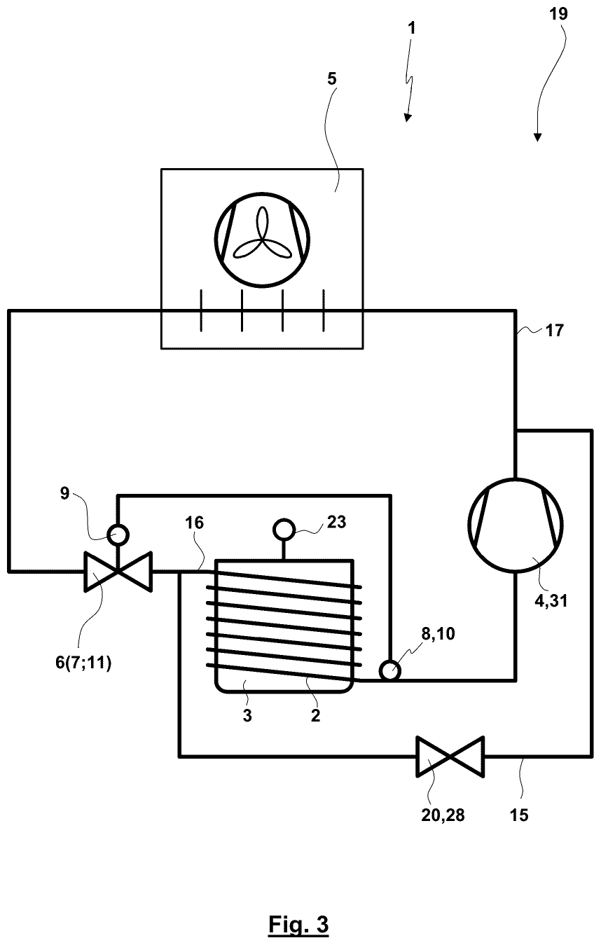

FIG. 3 schematically shows a centrifuge 19 with a centrifuge vessel 3 and a refrigerant circuit 1, in which a compressor 4, a condenser 5, an expansion unit 6, which can be embodied as a thermo-static injection valve 7 or electronically controlled expansion unit or throttle 11, and an evaporator 2 are connected to each other in this order in a circuit. A connection line 17 between the compressor 4 and the condenser 5 is connected to a connection line 16 between the expansion unit 6 and the evaporator 2 via a bypass line 15 with an electronically controlled valve 20 arranged therein. If the expansion unit 6 is embodied as a thermo-static injection valve 7, the thermo-static injection valve 7 preferably comprises a spring 9 and pressure controlled temperature sensing device 8 with the sensor 10 (see FIG. 1 and the state of the art cited at the beginning).

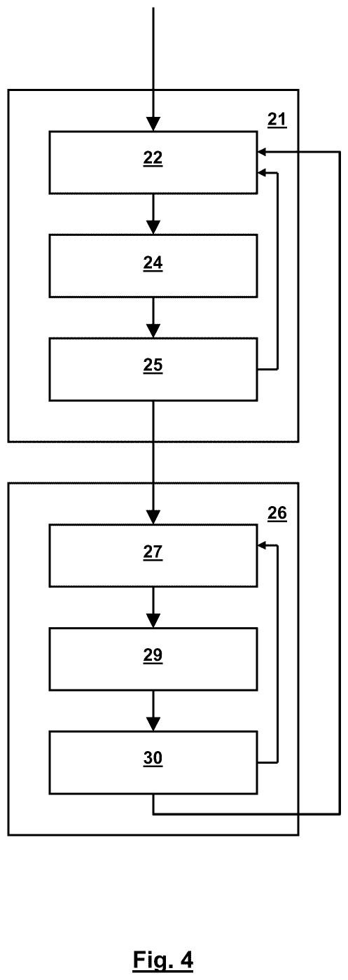

One embodiment of a method is shown in FIG. 4. First, the centrifuge 19 is operated in a normal operation mode 21 (possibly after the centrifuge 19 has run up). In the normal operation mode 21, the temperature in the centrifuge vessel 3 is controlled in a method step 22. This control initially involves controlling the flow of the refrigerant and the size of the opening or the throttling effect of the expansion device 6. As shown, this can be done in a passive manner if a thermo-static injection valve 7 is used as the expansion device 6. However, it is also possible for the temperature in the centrifuge vessel 3 to be determined by means of a temperature sensor 23 and for an electronic injection valve or an electronic throttle 11 to be controlled as required by means of a control unit. Alternatively or additionally, the temperature can be controlled by controlling the controllable compressor 4 by means of the control unit. In a method step 24, which can take place in the course of the aforementioned control, a difference is determined between a predetermined target temperature in the centrifuge vessel (e.g. entered by the user and stored in the control unit or read from a characteristic map for the selected operating data) and the temperature sensed by the temperature sensor 23 (e.g. the actual temperature of the centrifuge vessel, wherein the measured temperature can also be corrected or converted into the actual temperature in the centrifuge chamber within the centrifuge vessel 3 or this actual temperature can be estimated). In a method step 25, this difference is then compared with a threshold value, which may be 5 K, 3 K or 1 K, for example. If the difference is less than the threshold value and thus the actual temperature is smaller than the target temperature by less than the threshold value, the normal operation mode 21 can be continued by returning to method step 22.

If, however, the difference between the target temperature and the actual temperature is greater than the threshold value and thus the actual temperature is lower than the target temperature by more than the threshold value, a change is made from the normal operation mode 21 to an exceptional operation mode 26. In the exceptional operation mode 26, the valve 20 is controlled by the control unit in a method step 27 so that the flow rate in the bypass line 15 is increased. It is possible that the valve 20 is embodied as a 2/2-way solenoid valve. In this case, the 2/2-way solenoid valve 28 is controlled in the method step 27 in such a way that it is transferred from the closed position to the open position. Optionally, further measures can be taken in a method step 29 in order to increase the actual temperature, which can be achieved, for example, by suitable control of the controllable compressor 4 and/or control of the expansion unit 6. It is possible that this state is then maintained for a predetermined period of time. Immediately or after the time period, a method step 30 checks whether the difference between the target temperature and the actual temperature is still greater than the threshold value. If this is the case, the exceptional operation mode 26 is maintained and in method step 27 the valve 20 is opened, opened further than before or the opening state of the valve 20 is maintained. If, on the other hand, the actual temperature has risen to such an extent that it is at the most lower than the target temperature by the threshold value, a return to normal operation mode 21 takes place, so that method steps 22, 24, 25 are then carried out again.

It is also possible that in the bypass line 15 the valve 20 is connected in parallel with a line section comprising a predetermined passage cross section or a throttle with a predetermined throttle cross section, whereby a permanent flow through the bypass line 15 is ensured by means of this line section. In this case, the flow rate thus provided can be additionally influenced depending on the opening position of the valve 20. In this case, too, the valve 20 can be embodied as a 2/2-way solenoid valve or as any other discretely or continuously adjustable valve.

Preferably, the compressor 4 is embodied as a rolling piston compressor 31.

Many variations and modifications may be made to the preferred embodiments of the invention without departing substantially from the spirit and principles of the invention. All such modifications and variations are intended to be included herein within the scope of the present invention, as defined by the following claims

We claim:

1. A centrifuge comprising
a) a centrifuge vessel,
b) a refrigerant circuit with a circulating refrigerant and
c) a temperature sensor which senses a temperature that at least correlates with a temperature in the centrifuge vessel,
wherein
c) the refrigerant circuit comprises
ca) a controllable compressor,
cb) a condenser,
cc) an adjustable expansion unit and
cd) an evaporator delivering cooling energy to the centrifuge vessel,
d) a connection line of the compressor to the condenser is connected via a bypass line to a connection line between the expansion unit and the evaporator, and
e) an electronically controlled valve controlling a flow is arranged in the bypass line,
f) an electronic control unit is provided comprising control logic which, in the event that a difference between
a target temperature in the centrifuge vessel and
a temperature sensed by the temperature sensor,
is greater than a threshold value controls the valve so that the flow through the bypass line is increased, and
g) the control unit comprises control logic which
ga) in a normal operation mode, in which the absolute value of the difference of
the target temperature in the centrifuge vessel and
the temperature sensed by the temperature sensor,
is less than the threshold value or a second threshold value performs an open loop control or a closed loop control by means of one or two among the expansion unit and the compressor while the valve is in a first position, and
gb) in an exceptional operation mode in which the absolute value of the difference of
the target temperature in the centrifuge vessel and
the temperature sensed by the temperature sensor,
is greater than the threshold value or the second threshold value controls the valve into a second position that differs from the first position, wherein in the exceptional operation mode no control by means of the compressor takes place,
gc) wherein in the first position of the valve an opening cross section of the valve is smaller than an opening cross section of the valve in the second position.

2. The centrifuge according to claim 1 wherein in the exceptional operation mode there is no control by means of the expansion unit.

3. The centrifuge according to claim 1 wherein
a) the valve is a 2/2-way solenoid valve with a larger opening position and a smaller opening position and
b) the control unit comprising control logic which in the event that the difference of
the target temperature in the centrifuge vessel and
the temperature sensed by the temperature sensor,
is greater than the threshold value controls the 2/2-way solenoid valve from the smaller opening position to the larger opening position.

4. The centrifuge according to claim 2 wherein
a) the valve is a 2/2-way solenoid valve with a larger opening position and a smaller opening position and
b) the control unit comprising control logic which in the event that the difference of
the target temperature in the centrifuge vessel and
the temperature sensed by the temperature sensor,
is greater than the threshold value controls the 2/2-way solenoid valve from the smaller opening position to the larger opening position.

5. The centrifuge according to claim 3 wherein the control logic controls the 2/2-way solenoid valve for a predetermined period of time from the smaller opening position into the larger opening position.

6. The centrifuge according to claim 4 wherein the control logic controls the 2/2-way solenoid valve for a predetermined period of time from the smaller opening position into the larger opening position.

7. The centrifuge according to claim 3 wherein the larger opening position is an open position and the smaller opening position is a closed position.

8. The centrifuge according to claim 4 wherein the larger opening position is an open position and the smaller opening position is a closed position.

9. The centrifuge according to claim 1 wherein the expansion unit is a passive thermo-static injection valve.

10. The centrifuge according to claim 1 wherein the compressor is a rolling piston compressor.

11. The centrifuge according to claim 1 wherein the valve comprises a plurality of different opening cross sections and the control unit comprises control logic which, in the event that the difference of
the target temperature in the centrifuge vessel and
the temperature sensed by the temperature sensor,
is greater than a threshold value brings about a larger opening cross section depending on one or more among an absolute value of the difference, a rate of change of the difference and a time span that the difference is greater than the threshold value.

12. The centrifuge according to claim 1 wherein the compressor is operated permanently during operation of the centrifuge a rotational speed always being at least equal to a minimum rotational speed during operation.

13. A method for operating a centrifuge comprising a centrifuge vessel, a refrigerant circuit with a circulating refrigerant and a temperature sensor which senses a temperature which at least correlates with a temperature in the centrifuge vessel, the refrigerant circuit comprising a controllable compressor, a condenser, an expansion device and an evaporator which delivers cooling energy to the centrifuge vessel, wherein a connection line of the compressor to the condenser is connected via a bypass line to a connection line between the expansion unit and the evaporator, and an electronically controlled valve controlling a flow is arranged in the bypass line, the method comprising the following method steps,
a) testing whether a difference between a target temperature in the centrifuge vessel and a temperature sensed by the temperature sensor is greater than a threshold value,
b) in the event that the test shows that the difference is greater than the threshold value, increasing the flow through the bypass line,
c) wherein a test is carried out to determine whether an absolute value of the difference between the target temperature in the centrifuge vessel and the temperature sensed by the temperature sensor is less than the threshold value or a second threshold value, and
ca) if this is the case, the centrifuge is operated in a normal operation mode, in which open loop control or closed loop control is provided by means of one or two among the expansion unit and the compressor while the valve is in a first position, and
cb) if this is not the case, the centrifuge is operated in an exceptional operation mode in which the valve is controlled to a second position which differs from the first position, wherein in the exceptional operation mode there is no control by means of the compressor
wherein in the first position of the valve an opening cross section of the valve is smaller than an opening cross section of the valve in the second position.

14. The method according to claim 13 wherein in the exceptional operation mode there is also no control by means of the expansion unit.

15. The method according to claim 13 wherein a flow of the cooling energy through the evaporator is controlled by a passive thermo-static injection valve.

16. The method according to claim 14 wherein a flow of the cooling energy through the evaporator is controlled by a passive thermo-static injection valve.

17. The method according to claim 13 wherein the refrigerant is conveyed in the refrigerant circuit by means of a rolling piston compressor.

18. The method according to claim 14 wherein the refrigerant is conveyed in the refrigerant circuit by means of a rolling piston compressor.

19. The method according to claim 13 wherein
a) the valve is controlled into a plurality of different opening cross sections and
b) it is checked whether a difference between the target temperature in the centrifuge vessel and the temperature sensed by the temperature sensor is greater than a threshold value, and if this is the case, an increase in the opening cross section of the valve is brought about dependent on one or more among the absolute value of the difference, a changing speed of the difference and a period of time for which the difference is greater than the threshold value.

20. The method according to claim 13 wherein the compressor is operated permanently during operation of the centrifuge, wherein during operation the rotational speed always corresponds to at least a minimum rotational speed.

21. A computer-readable medium with control logic for carrying out a method for operating a centrifuge comprising a centrifuge vessel, a refrigerant circuit with a circulating refrigerant and a temperature sensor which senses a temperature which at least correlates with a temperature in the centrifuge vessel, the refrigerant circuit comprising a controllable compressor, a condenser, an expansion device and an evaporator which delivers cooling energy to the centrifuge vessel, wherein a connection line of the compressor to the condenser is connected via a bypass line to a connection line between the expansion unit and the evaporator, and an electronically controlled valve controlling a flow is arranged in the bypass line, the method comprising the following method steps,
a) testing whether a difference between a target temperature in the centrifuge vessel and a temperature sensed by the temperature sensor is greater than a threshold value,
b) in the event that the test shows that the difference is greater than the threshold value, increasing the flow through the bypass line,
c) wherein a test is carried out to determine whether an absolute value of the difference between the target temperature in the centrifuge vessel and the temperature sensed by the temperature sensor is less than the threshold value or a second threshold value, and
ca) if this is the case, the centrifuge is operated in a normal operation mode, in which open loop control or closed loop control is provided by means of one or two among the expansion unit and the compressor while the valve is in a first position, and
cb) if this is not the case, the centrifuge is operated in an exceptional operation mode in which the valve is controlled to a second position which differs from the first position, wherein in the exceptional operation mode there is no control by means of the compressor
wherein in the first position of the valve an opening cross section of the valve is smaller than an opening cross section of the valve in the second position.
